(19) United States
(12) Patent Application Publication
(10) Pub. No.: US 2014/0071013 A1
(43) Pub. Date: Mar. 13, 2014

(54) MULTIBAND MONOPOLE ANTENNA APPARATUS WITH GROUND PLANE APERTURE

(71) Applicants: Victor Shtrom, Los Altos, CA (US); Bernard Baron, Mountain View, CA (US); Chia-Ching Lin, San Jose, CA (US)

(72) Inventors: Victor Shtrom, Los Altos, CA (US); Bernard Baron, Mountain View, CA (US); Chia-Ching Lin, San Jose, CA (US)

(21) Appl. No.: 13/607,612

(22) Filed: Sep. 7, 2012

(51) Int. Cl. H01Q 1/48

(52) U.S. Cl. CPC H01Q 1/48
USPC 343/848

(57) ABSTRACT

A monopole antenna coupled to a metallic ground plane includes apertures used to steer a radio frequency (RF) beam of the monopole. The apertures may have a length, width, and distance from the monopole based on the wavelength of the RF signal used to drive the monopole antenna. The aperture may be coupled to one or more selective devices, such as PIN diodes, which may short portions of a metallic ground plane near the aperture. The shorted portions of the metallic ground plane provide for steering of the monopole radiation pattern. A circuit board metallic ground plane may include multiple apertures to direct different RF signal frequencies from a single monopole antenna. Multiple monopole antennas may be implemented over a metallic ground plane within a wireless device, each monopole antenna with corresponding apertures.

### BACKGROUND OF THE INVENTION

1. Field of the Invention

The present invention generally relates to wireless communications. More specifically, the present invention relates to monopole multi frequency antennas.

2. Description of the Related Art

In wireless communications systems, there is an ever-increasing demand for higher data throughput and reduced interference that can disrupt data communications. A wireless link in an Institute of Electrical and Electronic Engineers (IEEE) 802.11 network may be susceptible to interference from other access points and stations, other radio transmitting devices, and changes or disturbances in the wireless link environment between an access point and remote receiving node. The interference may degrade the wireless link thereby forcing communication at a lower data rate. The interference may, in some instances, be sufficiently strong as to disrupt the wireless link altogether.

FIG. 1 is a block diagram of a wireless device 100 in communication with one or more remote devices and as is generally known in the art. While not shown, the wireless device 100 of FIG. 1 includes antenna elements and a radio frequency (RF) transmitter and/or a receiver, which may operate using the 802.11 protocol. The wireless device 100 of FIG. 1 may be encompassed in a set-top box, a laptop computer, a television, a Personal Computer Memory Card International Association (PCMCIA) card, a remote control, a mobile telephone or smart phone, a handheld gaming device, a remote terminal, or other mobile device.

In one particular example, the wireless device 100 may be a handheld device that receives input through an input mechanism configured to be used by a user. The wireless device 100 may process the input and generate a corresponding RF signal, as may be appropriate. The generated RF signal may then be transmitted to one or more receiving nodes 110-140 via wireless links. Nodes 120-140 may receive data, transmit data, or transmit and receive data (i.e., a transceiver).

Wireless device 100 may also be an access point for communicating with one or more remote receiving nodes over a wireless link as might occur in an 802.11 wireless network. The wireless device 100 may receive data as a part of a data signal from a router connected to the Internet (not shown) or a wired network. The wireless device 100 may then convert and wirelessly transmit the data to one or more remote receiving nodes (e.g., receiving nodes 110-140). The wireless device 100 may also receive a wireless transmission of data from one or more of nodes 110-140, convert the received data, and allow for transmission of that converted data over the Internet via the aforementioned router or some other wired device. The wireless device 100 may also form a part of a wireless local area network (LAN) that allows for communications among two or more of nodes 110-140.

For example, node 110 may be a mobile device with Wi-Fi capability. Node 110 (mobile device) may communicate with node 120, which may be a laptop computer including a Wi-Fi card or wireless chipset. Communications by and between node 110 and node 120 may be routed through the wireless device 100, which creates the wireless LAN environment through the emission of RF and 802.11 compliant signals.

Efficient design of wireless device 100 is important to provide a competitive product in the market place. It is important to provide a wireless device 100 with a small footprint that can be utilized in different environments. Wireless device 100 may have dipole antenna elements built into the circuit board or manually mounted to the wireless device. When mounted manually, matching antenna elements are attached to opposing surfaces of the circuit board and typically soldered although those elements may be attached by other means.

A monopole antenna includes only a single radiating element and is coupled to a ground plane of a transmitter. The monopole radiation reflects from the ground plane to provide radiation in a dipole antenna radiation pattern. Dipole antenna elements may provide beam steering RF signals but are more costly to manufacture than monopole antennas. There is a need for an improved beam steering antenna apparatus for use in wireless devices.

### SUMMARY OF THE PRESENTLY CLAIMED INVENTION

A monopole antenna is coupled to a ground plane, such as a metallic ground plane, that includes apertures used to steer a radio frequency (RF) beam of the monopole. The apertures may have a length, width, and distance from the monopole based on the wavelength of the RF signal used to drive the monopole antenna. The aperture may be in any of several shapes and patterns, including circular, square, and other patterns about the footprint of the antenna on a circuit board. One or more radio frequency switches, such as PIN diodes, may selectively provide a short circuit at a portion of the ground plane near the aperture. The portions of the ground plane near the aperture and at which a short circuit is generated provide for steering of the monopole radiation pattern. A circuit board ground plane may include multiple apertures to direct different RF signal frequencies from a single monopole antenna. Multiple monopole antennas may be implemented over a ground plane within a wireless device, each monopole antenna with corresponding apertures. Using the apertures within a ground plane with a monopole antenna saves manufacturing cost and may contribute to providing a low profile for a wireless device.

An embodiment of a wireless device for transmitting a radiation signal includes a circuit board, an antenna, an aperture and a radio frequency switch. The circuit board may include a metallic ground and at least one substrate layer. The antenna may be coupled to the circuit board and transmit radio frequency (RF) signals. The aperture may be in the metallic ground plane layer and the selectable shorting device may be selectable and positioned on the metallic ground plane over the aperture. The shorting device may be selectable to reflect a radio frequency (RF) signal broadcast by the antenna.

### BRIEF DESCRIPTION OF THE FIGURES

FIG. 1 is a block diagram of a wireless device in communication with one or more remote devices.

FIG. 2 is a block diagram of a wireless device.

FIG. 3 illustrates a perspective view of a circuit board having monopole antennas and a metallic ground plane having apertures.

FIG. 4 illustrates a side view of a circuit board having a monopole antenna and a metallic ground plane having apertures.

FIG. 5 illustrates a top view of a circuit board having a monopole antenna and a metallic ground plane having apertures.

FIG. 6 illustrates a top view of another circuit board having a monopole antenna and a metallic ground plane having apertures.

### DETAILED DESCRIPTION

An antenna apparatus may include one or more antennas coupled to a circuit board having a ground plane, such as a metallic ground plane, with one or more apertures. The apertures may be used to steer a radio frequency (RF) beam of the one or more monopole antennas. Each monopole antenna may have one or more sets of corresponding apertures. Each aperture or set of apertures may reflect and/or direct different RF signal frequencies from a single monopole antenna. A radio frequency switch such as a PIN diode switch may be positioned over the aperture and be selected to provide a short circuit at that portion of the aperture. The short circuit makes that portion of the aperture act as a ground plane with respect to the RF signal. Beam steering of an RF signal may be provided by selectively providing a short across portions of the aperture which are not to act as a reflector or director.

An aperture used for beam steering may be designed based on the wavelength of one or more RF signals transmitted by a corresponding monopole antenna. A ground plane such as a metallic ground plane may have apertures having a length, width, and a distance from the monopole based on the wavelength of the RF signal used to drive the monopole antenna. Multiple apertures may be used with a single monopole antenna to reflect different frequency RF signals. The aperture may be in any of several shapes and patterns, including slots forming circular, square, and other shapes about the footprint of the monopole antenna on a circuit board. Using the a monopole antenna with apertures to provide beam steering saves manufacturing cost and helps provide a lower profile as compared to dipole antenna-based wireless devices.

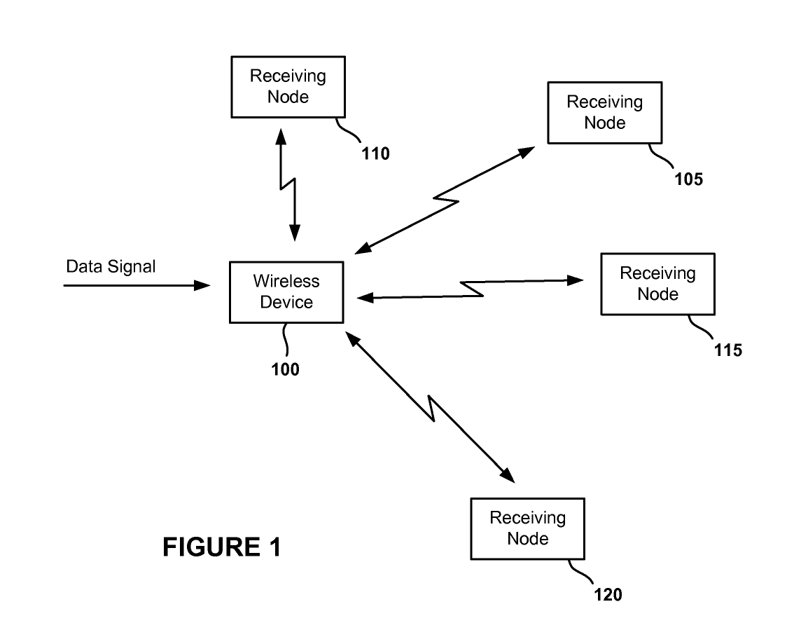

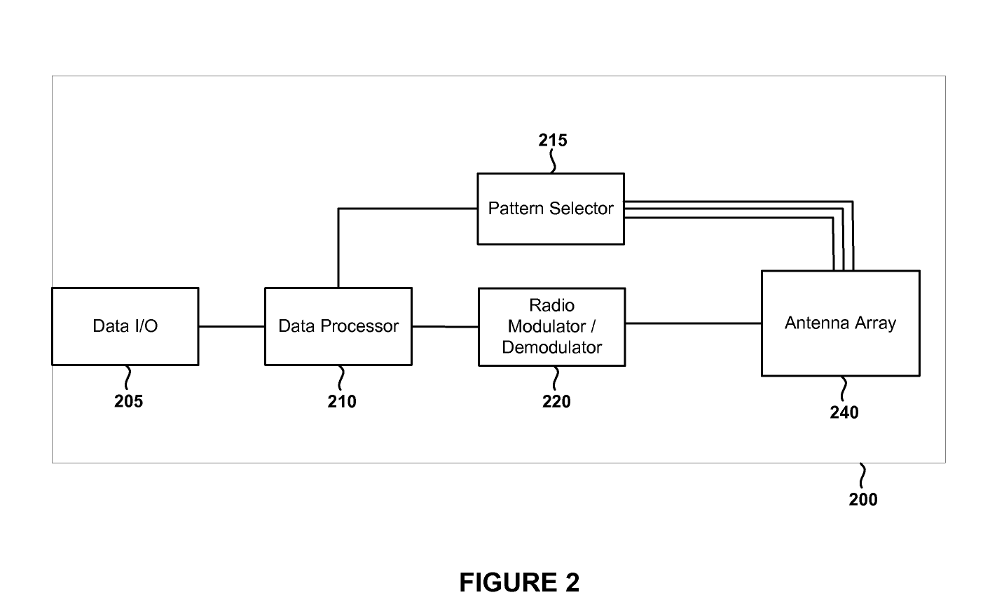

FIG. 2 is a block diagram of a wireless device 200. The wireless device 200 of FIG. 2 can be used in a fashion similar to that of wireless device 100 as shown in and described with respect to FIG. 1. The components of wireless device 200 can be implemented on one or more circuit boards. The wireless device 200 of FIG. 2 includes a data input/output (I/O) module 205, a data processor 210, radio modulator/demodulator 220, a pattern selector 215, and antenna array 240.

The wireless device 200 of FIG. 2 may implement a MIMO system. The MIMO system may include multiple MIMO chains, wherein each chain communicates using a monopole antenna.

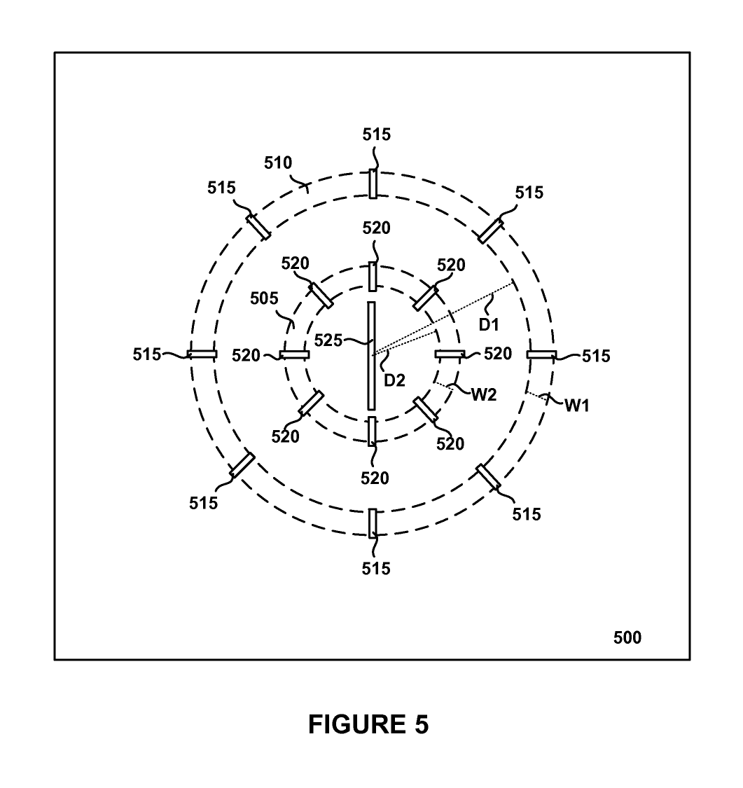

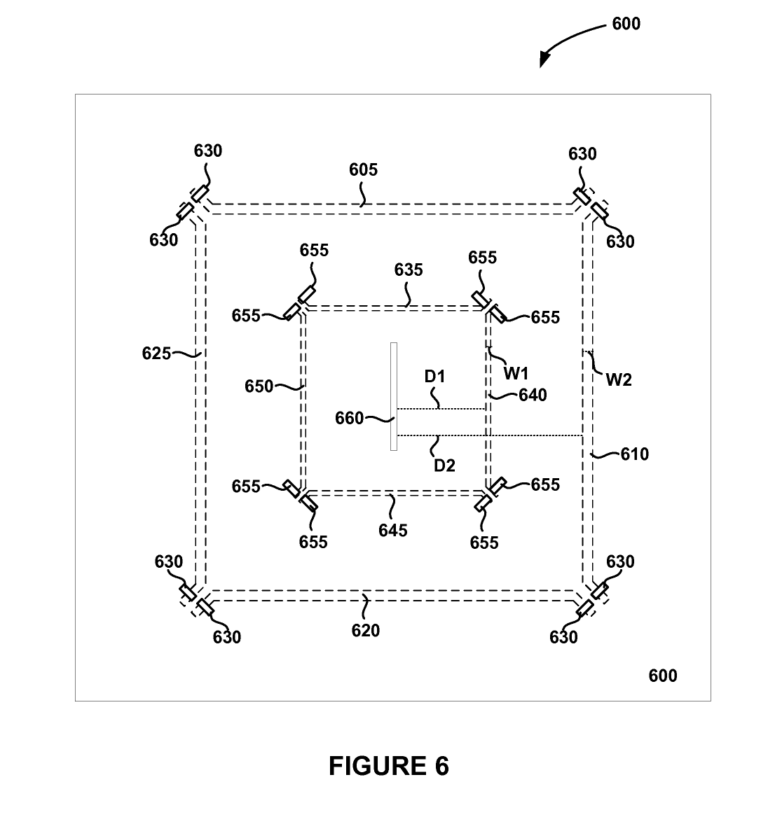

Radio frequency switches may be used within wireless device 200 between pattern selector and the monopole antennas of antenna array 240, such as for example to select aperture portions within a metallic ground plane. Examples of radio frequency switches are discussed with respect to FIGS. 5 and 6.

The data I/O module 205 of FIG. 2 receives a data signal from an external source such as a router. The data I/O module 205 provides the signal to wireless device circuitry for wireless transmission to a remote device (e.g., nodes 110-140 of FIG. 1). The wired data signal can be processed by data processor 210 and radio modulator/demodulator 220. The processed and modulated signal may then be transmitted via one or more antenna elements, including monopole antenna elements, within antenna array 240 as described in further detail below. The data I/O module 205 may be any combination of hardware or software operating in conjunction with hardware.

The pattern selector 215 of FIG. 2 can select one or more radio frequency switches within antenna array 240. Each radio frequency switch may be coupled across a portion of an aperture within a metallic ground plane to selectively short portions of an aperture to provide signal beam steering. Pattern selector 215 may also select one or more reflectors/directors for reflecting the signal in a desired direction. Processing of a data signal and feeding the processed signal to one or more selected antenna elements is described in detail in U.S. Pat. No. 7,193,562, entitled “Circuit Board Having a Peripheral Antenna Apparatus with Selectable Antenna Elements,” the disclosure of which is incorporated by reference.

Antenna array 240 can include an antenna element array, a metallic ground plane having apertures and selectable radio frequency switches, and reflectors. The antenna element array can include one or more monopole antenna elements. Each monopole antenna element may be mounted to a circuit board and may be configured to operate at one or more particular frequencies, such as 2.4 GHz and 5.0 GHz. Antenna array 240 may also include a reflector/controller array. The mountable antenna element and reflectors can be located at various locales on the circuit board of a wireless device.

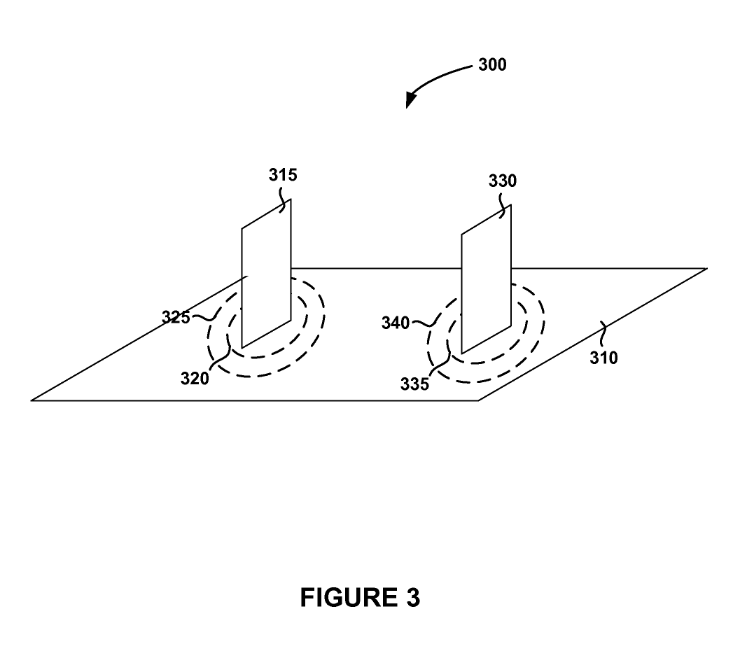

FIG. 3 illustrates a perspective view of a circuit board having monopole antennas and a ground plane having apertures. The ground plane may include a metallic ground plane. Monopole antenna elements 315 and 330 may be coupled to circuit board 310. The monopole antenna element 315 may be a quarter wavelength element and reside above a metallic ground plane within circuit board 310.

Circuit board 310 may include one or more substrate layers and ground planes. One or more of the ground planes may include one or more apertures 320, 325, 335, and 340, illustrated by dashed lines in FIG. 3. Each aperture may include a hole or opening such as a continuous slot in a ground plane of the circuit board. The aperture may be formed by any of a variety of methods, including during the manufacturing process by removing portions of the ground plane. As shown, multiple apertures may be formed for each monopole antenna element to provide beam forming for different frequencies of RF signals. For example, aperture 325 encompasses aperture 320 and aperture 340 encompasses aperture 335. Though FIG. 3 illustrates an antenna apparatus with two monopole antennas 315 and 330, more or fewer monopole antennas may be used within an antenna apparatus of the present invention.

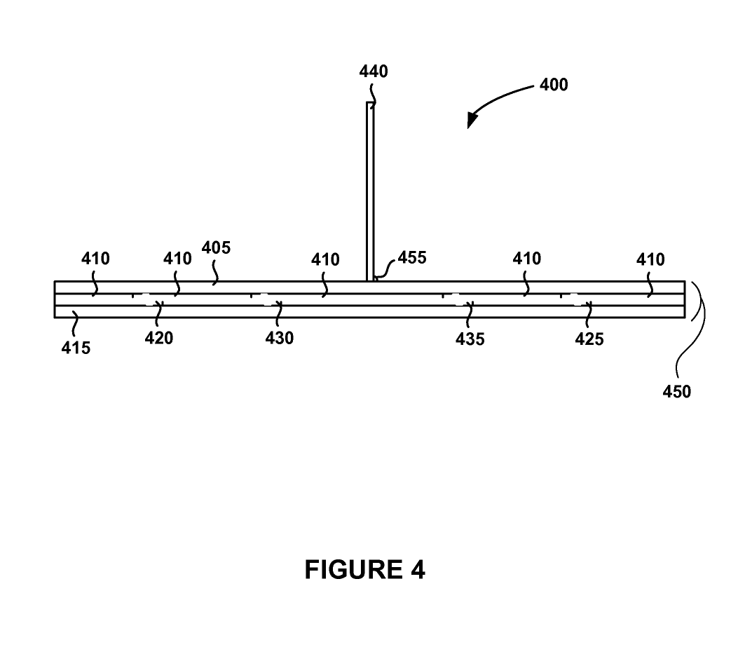

FIG. 4 illustrates a side view of a circuit board 450 having a monopole antenna 440 and a ground plane having apertures. The circuit board 450 includes a top layer 405, metallic ground plane 410, and bottom layer 415. Though only three layers are shown, circuit board 450 may have more or less than the three layers illustrated in FIG. 4.

Antenna element 440 mounts to the top surface of the circuit board 450. The antenna element 440 may be inserted through slots that extend through one or more of circuit board top layer 405, ground layer 410, and bottom layer 420, or may be coupled to the surface in some other manner. The monopole antenna element 440 may be coupled to radio modulator/demodulator 220 to receive an RF signal and radiate at one or more frequencies. A portion of the monopole antenna radiation may be reflected by metallic ground plane 410. The monopole antenna element radiation and reflected radiation may combine to provide a radiation pattern similar to that provided by a dipole antenna.

Metallic ground plane 410 may include a number of apertures 420, 425, 430 and 435. The apertures are formed around monopole antenna element 440. For example, apertures 430 and 435 may be part of a single set of apertures, such as a circular or semi-circular slot, formed around monopole antenna element 440. Apertures 420 and 425 may also form an aperture around monopole antenna element 440. Apertures 430 and 435 are closer to monopole antenna element 440 and, along with one or more radio frequency switches, may direct an RF signal at a first, higher frequency while apertures 420 and 425 are positioned further away from monopole antenna element 440 and may be designed to direct, using one or more radio frequency switches, an RF signal at a second, lower frequency. The apertures closer to the monopole antenna element 440 may beam steer a higher frequency RF signal while the apertures further from the monopole antenna element 440 may beam steer a lower frequency RF signal.

To minimize or reduce the size of the monopole antenna 440, each monopole antenna element may incorporate one or more loading structures. By configuring a loading structure to slow down electrons and change the resonance of each monopole antenna element, the monopole antenna element becomes electrically shorter. In other words, at a given operating frequency, providing loading structures reduces the dimension of the monopole antenna element. Providing the loading structures for one or more of the monopole antenna element minimizes the size of the antenna element.

Circuit board 450 includes radio frequency feed port 455 selectively coupled to antenna 440. Although one antenna element is depicted in FIG. 4, more antenna elements can be implemented and selectively coupled to radio frequency feed port 455. Further, while antenna element 440 of FIG. 4 is oriented substantially in the middle of circuit board substrate, other shapes and layouts, both symmetrical and non-symmetrical, can be implemented. Radio frequency feed port 455 may be coupled to one or more monopole antenna elements to provide each monopole antenna with an RF signal

The pattern selector 215 may include radio frequency switches, such as diode switches 225, 230, 235 of FIG. 2, a GaAs FET, or other RF switching devices to select one or more monopole antenna elements and/or to short portions of an aperture. A PIN diode may include a single-pole single-throw switch to switch each antenna element either on or off (i.e., couple or decouple antenna element 440 to the radio frequency feed port 310).

A series of control signals can be used to bias each PIN diode. With the PIN diode forward biased and conducting a DC current, the PIN diode switch is on, and a PIN diode placed over an aperture may provide a short across that portion of the aperture. With the diode reverse biased, the PIN diode switch is off. The PIN diodes may be placed over an aperture to provide a short at a selected portion of the aperture. In various embodiments, the radio frequency feed port 455, the pattern selector 215, and the antenna elements 440 may be close together or spread across the circuit board.

One or more light emitting diodes (LED) (not shown) can be coupled to the antenna element selector. The LEDs function as a visual indicator of which of the antenna elements 320-370 is on or off. In one embodiment, an LED is placed in circuit with the PIN diode so that the LED is lit when the corresponding antenna element is selected.

Monopole antenna element 440 can be coupled to the circuit board 450 using slots in the circuit board, coupling pads, or other coupling methods known to those skilled in the art. In some embodiments, reflectors for reflecting or directing the radiation of a mounted antenna element can also be coupled to the circuit board at one or more coupling pads. Circuit board mounting pads and coupling pad holes are described in more detail in U.S. patent application Ser. No. 12/545,758, filed on Aug. 21, 2009, and titled “Mountable Antenna Elements for Dual Band Antenna,” the disclosure of which is incorporated herein by reference.

The antenna components (e.g., monopole antenna element 440) are formed from RF conductive material. For example, the monopole antenna element 440 and the ground components 410 can be formed from metal or other RF conducting material.

Externally mounted reflector/directors, if any, may further be implemented in circuit board 450 to constrain the directional radiation pattern of one or more of the antenna elements in azimuth. Other benefits with respect to selectable configurations are disclosed in U.S. patent application Ser. No. 11/041,145 filed Jan. 21, 2005 and entitled “System and Method for a Minimized Antenna Apparatus with Selectable Elements,” the disclosure of which is incorporated herein by reference.

FIG. 5 illustrates a top view of a circuit board having a monopole antenna and a metallic ground plane having apertures. Circuit board 500 includes apertures 505 and 510, radio frequency switches 515 and 520, and monopole antenna element 525. The circuit board 500 includes a substrate having at least first side and a second side that can be substantially parallel to the first side. The substrate may comprise, for example, a PCB such as FR4, Rogers 4003 or some other dielectric material.

Aperture 505 includes a plurality of radio frequency switches 520 placed over, across, or straddling the aperture. As an RF signal of a particular frequency is transmitted by an antennal element 525 towards the ground plane, the reflection of the RF signal induces a current in aperture 505. Aperture 505 may have a length, width and distance from the antenna based on the particular RF frequency in order for the current to be generated by the reflected RF signal. The induced current in aperture 505 causes the aperture to act as a director and/or reflector of the RF signal. Radio frequency switches placed over aperture 505 may be selected to provide a short circuit, or “short”, across the aperture. Each short across portions of aperture 505 causes that portion of the aperture to no longer act as a director and/or reflector, but rather to behave as the ground plane with respect to the RF signal.

Each radio frequency switch positioned over aperture 505 may be selectively coupled to a selecting mechanism such as pattern selector 215. By selecting one or more radio frequency switches 520, the RF frequency beam provided by the monopole antennal element 525 can be steered (i.e., by portions of the slot which are not shorted) in a desired direction.

Aperture 510 is formed as a circular slot that extends around (i.e., encompasses) monopole antenna element 525. The circular aperture 510 is positioned at a distance D1 (radius of circle formed by aperture 510) from monopole antenna element 525 and has a width of W1. The length of aperture 505 is the circumference of the circular aperture, provided approximately by 2πr or 2π(D1).

Aperture 505 is formed as a circular slot that extends around monopole antenna element 525 and inside aperture 510. Aperture 505 is positioned at a distance D2 from monopole antenna element 525 and has a width of W2. The length of aperture 505 is provided approximately by 2π(D2).

The width and length of an aperture for providing beam steering as well the distance of the aperture from a monopole antenna may be determined based on the frequency of the RF signal the aperture and radio frequency switches are intended to reflect via beam steering. For example, for shorter wavelength RF signals, an aperture with short circuit causing radio frequency switches may be provided closer to a monopole antenna element. An aperture with short circuit causing radio frequency switches for beam steering larger wavelength signals may be positioned further from a monopole antenna. In some embodiments, multiple apertures for a single antenna such as a monopole antenna may be used to reflect signals of 5.0 GHz signal, 2.4 GHz signal, and other frequencies of RF signals. If aperture 510 may be used to reflect/direct a 2.4 GHz RF signal and aperture 505 may be used to direct/reflect a 5.0 GHz signal, the dimension of each aperture may be selected such that aperture 510 with radio frequency switches 515 may beam steer the 2.4 GHz signal while appearing invisible and not significantly affecting the radiation pattern of a 5.0 GHz signal. Aperture 505 with radio frequency switches 520 may beam steer the 5.0 GHz signal while appearing invisible and not significantly affecting the radiation pattern of a 2.4 GHz signal.

FIG. 6 illustrates a top view of a circuit board having a monopole antenna and a metallic ground plane having apertures. Circuit board 600 includes apertures 605, 610, 615, and 620 forming an outer square shape aperture, apertures 635, 640, 645, and 650 forming an inner square shape aperture, radio frequency switches 630 and 655, and monopole antenna element 660. The circuit board of FIG. 6 may be similar to the circuit board of FIG. 5.

Each of apertures 605, 610, 615, and 620 is formed as a relatively straight slot with outward-bent ends and includes a radio frequency switches 655 placed at each end of each aperture. The apertures are positioned to form a square-like shape around monopole antenna 660 at distance D2 from antenna 660 and each have a width W2. The length of each aperture is approximately the length of each slot between diodes 630. Each radio frequency switches 630 may be selectively coupled to a selecting mechanism such as pattern selector 215. When one of the radio frequency switches 630 is selectively switched on, a short circuit is formed across the corresponding aperture. By selecting one or more radio frequency switches 630, the RF frequency beam provided by the monopole antennal element 660 can be steered to a desired direction, such as that associated with a receiving node.

Apertures 635, 640, 645, and 650 also form a square shape but are positioned closer to monopole antenna element 660, within the square formed by apertures 605, 610, 615 and 620. Apertures 635, 640, 645, and 650 are positioned at distance D1 from antenna 660 and each have a width W2. A selectable radio frequency switch 655 is placed at each end of each of each of apertures 635, 640, 645, and 650. Radio frequency switches 655 are placed over, across, or straddling apertures 605, 610, 615 and 620. When a radio frequency switch 655 is switched on, a short circuit is formed across the aperture. In FIG. 6, the apertures 605, 610, 615 and 620 with radio frequency switches 630 may be used to beam steer a 2.4 GHz signal while inner apertures 635, 640, 645, and 650 with radio frequency switches 655 may be used to beam steer a 5.0 GHz signal.

The embodiments disclosed herein are illustrative. Various modifications or adaptations of the structures and methods described herein may become apparent to those skilled in the art. Such modifications, adaptations, and/or variations that rely upon the teachings of the present disclosure and through which these teachings have advanced the art are considered to be within the spirit and scope of the present invention. Hence, the descriptions and drawings herein should be limited by reference to the specific limitations set forth in the claims appended hereto.

What is claimed is:

1. A wireless device for transmitting a radiation signal, comprising:
a circuit board including a metallic ground and at least one substrate layer;
an antenna coupled to the circuit board and transmitting radio frequency (RF) signals;
an aperture in the metallic ground plane; and
at least one selectable radio frequency switch positioned over the aperture.

2. The wireless device of claim 1, wherein the antenna is perpendicular to the circuit board.

3. The wireless device of claim 1, wherein the aperture has a length related to the RF signal wavelength.

4. The wireless device of claim 1, wherein the aperture has a width related to the RF signal wavelength.

5. The wireless device of claim 1, wherein the aperture is positioned a distance away from the antenna, the distance related to RF signal wavelength.

6. The wireless device of claim 1, the metallic ground plane including a second aperture, the second aperture having a second radio frequency switch selectable to reflect a second RF signal broadcast by the monopole antenna, the second RF signal having a different frequency than the first RF signal.

7. The wireless device of claim 1, wherein the selectable radio frequency switch includes a PIN diode.

8. The wireless device of claim 7, wherein the radiation pattern of the antenna is controlled by selecting one or more selectable radio frequency switches.

9. The wireless device of claim 1, wherein the first aperture encompasses the second aperture within the metallic ground plane, the second aperture and a second radio frequency switch causing reflection of an RF signal by the metallic ground plane, the second RF signal having a higher frequency than the RF signal reflected by the metallic ground plane near the first aperture.

10. The wireless device of claim 1, wherein the aperture is formed by a single opening in the metallic ground plane.

11. The wireless device of claim 1, wherein the aperture is formed by a plurality of openings in the metallic ground plane.

12. The wireless device of claim 1, wherein the antenna is a monopole antenna.
